(19) United States
(12) Patent Application Publication
(10) Pub. No.: US 2021/0201640 A1
(43) Pub. Date: Jul. 1, 2021

(54) System and mothods of sorting out harmless versus suspicious visitors inside a protected perimeter

(71) Applicant: Haim Harel, New York, NY (US)

(72) Inventor: Haim Harel, New York, NY (US)

(21) Appl. No.: 16/974,319

(22) Filed: Dec. 28, 2020

Related U.S. Application Data
(60) Provisional application No. 62/955,940, filed on Dec. 31, 2019.

(51) Int. Cl. G08B 13/196; G06K 9/00; G06N 20/00; H04R 27/00

(52) U.S. Cl. CPC G08B 13/19615; G08B 13/19608; G06K 9/00369; G07C 9/32; G08B 13/19645; H04R 27/00; G06N 20/00

(57) ABSTRACT

An artificial intelligence (AI) assisted cameras system and methods, designated to sort out visitors to a protected perimeter into either harmless or suspicious, vetting irregular behaviors via observation and analysis of people's response to automated loudspeaker inquires and instructions. While acceptable behavior is noted and dismissed, confirmed suspicious one triggers alerting and summoning of professional human guard. The goal of the system is to engage a human intervention as little as possible, while doing it with minimal false negative.

### CROSS REFERENCE TO RELATED APPLICATIONS

This application claims benefit of U.S. Provisional Patent Application No. 62/955,940 filed on Dec. 31, 2019. (EFS ID 38177293); (Confirmation Number 9463)

### FIELD OF THE INVENTION

The present invention relates generally to machine-learning object detection, identification and classification, face recognition, computer vision event interpretation, and speech recognition applications

### BACKGROUND OF THE INVENTION

Traditional camera systems that are equipped with 2-way audio link and motion detection sensors, have been well received by home and business owners, allowing them to get an audio-visual alert when someone shows up at their doorstep, enabling remote communicate with a friendly visitor, or alternatively a warning the visitor away and call for help, if the person looks like a thieve or a burglar.

More advanced prior art solutions are augmenting such cameras with computer vision software, capable of eliminating false alerts created by passing cars, trees branches swaying or light changes, thus significantly increasing alerts' reliability; still, home and business owners are flooded with audio-visual alerts during activity hours, created by normal traffic of harmless people detected coming in or going out while carrying their daily routine tasks.

This invention depicts a system and methods of automatic sorting out of harmless visitors from suspicious ones, enhancing prior art AI-based cameras systems that monitor perimeters and their borders. By doing so, not only does it reduce alerts' load for consumers who exercise do-it-yourself monitoring, but also enables professional monitoring services to assume the task of audio-visual vetting of suspicious visitors, protecting homes and businesses by warning burglars to back off before breaking in, or summoning law enforcement intervention with convincing evidence of a crime in progress.

The term “perimeter” as used herein is defined as an area surrounded by a marked border, or an artificial or natural fence

The term “legitimate entrance” as used herein is defined as an opening in a fence of a perimeter, or a marked pathway leading from a point in the border to a doorway of a house or another installation standing inside the perimeter

The terms “home owner” or “user” or just “owner” are used interchangeably and have the same meaning, referring to household members or business managers whose premises and perimeter are protected by the said AI based cameras system

The term “AI system” used throughout this invention means software comprising

video analytics, voice processing, timers setting and tracking, announcements activation, machine learning and automatic decision making. The AI system may reside in either inside a camera, in an external equipment next to it, in a remote server, or a combination thereof.

The terms “professional monitoring”, “Human operator”, “human guard” are used interchangeably and have the same meaning, referring to protection services manned by trained guards who stand by to intervene and assist when the AI system or an individual sends and alert

FIG. 1 is an illustration of a protected apparatus 100 according to the prior art, comprising perimeter border 101 with an entry gate 102; inside the perimeter a house 103 is protected by one or more computer vision assisted cameras e.g. 111, 112, 113, 114 and adjacent speakers & microphones 1111, 1121, 1131, 1141 which cover the zones 121, 122, 123, 124, respectively; the said speakers may be built into the cameras or installed externally close to it; a person 131 walk in thru the 102 gate and walks via a path 105 towards the house's door 104

An AI based monitoring system may link the cameras and it's 2-way voice cannel to home-owners mobile phone 160 or to a professional monitoring service 150, or both

The AI software may perform object and face recognition, sending alerts to the user or to said professional monitoring service center, each time a stranger is detected inside the perimeter; such professional guards may intervene via the loudspeakers' system or by summoning law enforcement

### SUMMARY OF THE INVENTION

The present invention, in embodiments thereof, provides a system and methods which may implement a combination of computer vision tools, machine learning techniques, canned messages announcements over a loudspeaker, speech recognition based dialoging, and interactive procedures, all together comprising an AI system which facilitates an automatic assessment of people who enter or leave a monitored perimeter

Such assessment is aimed to tag people who enter or leave the perimeter as well intent ones when behaving according to specified criteria; all others are tagged as potential threats.

The assessment is based on tracking the behavior and demeanor of people, recognizing or classifying them via fitting into a set of rules as well as via machine learning processing.

When irregularity is detected, the AI system may announce a pre-determined canned warning via a loudspeaker, compelling the visitor to either comply, ignore, or defy the instruction; such additional classification may corroborate or dismiss the AI system's initial tagging.

The invention also outlines a supervised home owner participation in the visitor's vetting process, done by facilitating voice processing of a 2-way audio-visual dialog that may take place between a home owner and a person standing next to the home doorway. Such voice processing may provide an alert to the AI system regarding start and end of such a dialog, as well warning of a possible emergency content that warrants a professional human guard intervention

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be more fully understood by reference to the following detailed description when read with the accompanying drawings in which:

FIG. 1 descries an apparatus comprising an AI based cameras protected perimeter, alerting users or professional monitoring service each time a stranger is detected inside a protected perimeter, according the prior art

FIG. 2 describes an apparatus comprising an AI based cameras protected perimeter, alerting either the user or a monitoring center or both; the AI system performs object and face recognition, validating strangers' timely and orderly departure from the perimeter, or else, summoning intervention by a human operator residing in a monitoring station, either local or remote

FIG. 3 outlines an apparatus comprising an AI based cameras' monitoring system, connected to human operator, using object and face recognition to detect incoming strangers who may leave a parcel, e.g. a letter or a package, and validate their timely and orderly departure from the perimeter

FIGS. 4A and 4B depict a computer vision-based detection of a person loitering outside and inside a border line of a protected perimeter, respectively

FIGS. 5A, 5B and 5C depict a computer vision-based detection of a person walking at an inconsistent trajectory, in geometric dimensions, in temporal dimension, and with frequent glancing left and right, respectively

FIG. 6 depicts a computer vision-based detection of a person popping up inside a protected perimeter, without previously detected entering the it via a monitored legitimate perimeter gate or entrance

FIG. 7 depicts a computer vision-based detection of a person disappearing from the camera field of view, not by exiting via a monitored legitimate perimeter gate or entrance

FIG. 8 depicts a computer vision-based detection of a person turning around or turning his/her head away, right after a loudspeaker announcement is heard

FIG. 9 depicts a computer vision-based detection of a person hiding his/her face, right after a loudspeaker announcement is heard

FIG. 10 depicts a computer vision-based detection of a person breaks his/her stride and starts running, right after a loudspeaker announcement is heard

FIG. 11 depicts a computer vision-based detection of a driver propels his car into a protected perimeter, failing to step out of the car

FIG. 12 depicts a flowchart of events started by a detection of a person within a protected perimeter

FIG. 13 depicts a flowchart of events started by a disappearance of a person from a camera's field-of-view (FOV)

FIG. 14 depicts a list of behavior types and its classifications

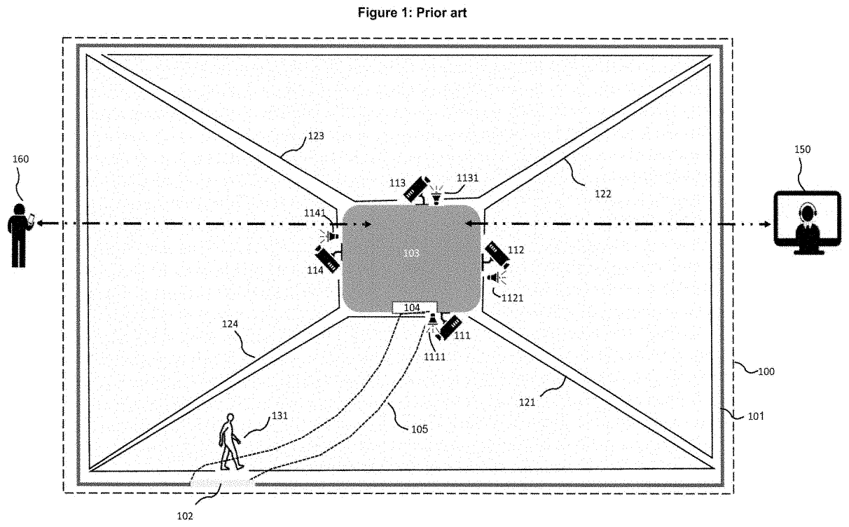

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

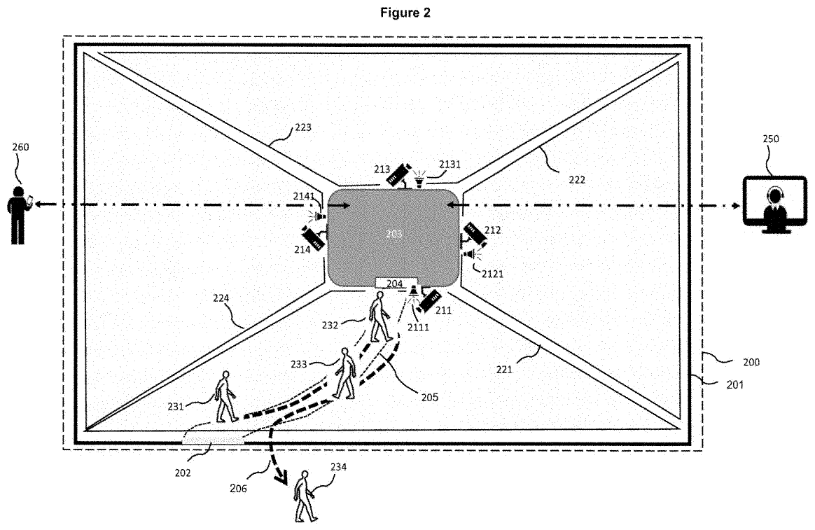

FIG. 2 shows a protected apparatus perimeter 200, defined by a border 201 which may be a fence or a barrier or a marking of the ground, or a virtual line defined in a real estate map. The perimeter has a main entrance 202 which may be a gate in a fence, or an edge of a pathway 205 that runs from said entrance into the said perimeter. Inside the perimeter a residential house 203 is standing with an access door 204, representing one or more possible houses, each with one or more access doors; it may also be a non-residential house or other installations that include valuables and possibly people. The house is protected by either one camera installed next to the house's access door 211, or to more cameras e.g. 212, 213, 214 covering areas essentially not covered by camera 211; there could be more or less cameras covering the surrounding area around the house, or installed in the perimeter in other places than the house's walls are or roof. The cameras are preferably equipped with laud-speakers 2111, 2121, 2131, 2141, either built-in or externally installed close to the cameras. Each camera covers a certain part of the perimeter area depicted as sector 221, 222, 223, 224, respectively.

The apparatus 200 may be augmented by a remote monitoring human operator 250, connected to the house via a video & audio link 251, capable of taking over the management of the event firm the AI system, communicating with the visitor, and responding to non-obedient behavior by sending a guard or summoning law enforcement help

A depiction of an arriving and then exiting person, is shown from the perimeter entrance 202 towards the access door 204, and then back outside the perimeter. The person progresses inside, from locations 231 to 232 and then retreats from that point via locations such as 233 and 234 outside and away from the perimeter.

The person's trajectory 206 is showed to be a consistent track, mostly confined to a paved path 205 or an unpaved route that stretches between the perimeter said entrance and the said access door; similar trajectory consistency is shown on the way back and out.

Camera 211 which is installed next the access door 204, or any other camera that is installed to any access door so that it can view the person's face and may initiate a vetting process

One of such a vetting process is trying to perform Face Recognition, and if successful, it performs search of a previously train data, looking for a match to one of the Home Owners, or previously captured family members, hired help, or any other previously authorized person whose face are part of a “white listed” people.

Upon positive recognition, the AI system issues an “all clear” tagging of the entering event, and may announce a greeting e.g. “Welcome home Mrs. Jones” via a built-in or adjacent loudspeaker 2111

Otherwise, vetting may continue by the AI controlled system sending an alert to the Home Owners, either to their mobile phones or to some indoors intercom system, while continuing tracking the whereabout and behavior of the person, for a given answering time period, e.g. 15 seconds.

In case the answering period time is elapsed, the AI system may issue a vocal invitation to leave a voice mail message, then may grant a dictating time period for recording a message e.g. another 15 seconds, and upon expiration, may issue a loudspeaker departure announcement e.g. “Thank you and goodbye”

The vetting may continue to tracking the expiration of both the answering and the dictating time periods, and in any case, following a maximum allowable stay time—labeled as grace-period timeline—next to the door e.g. 30 seconds, a person without ill intentions is expected to turn around and leave the perimeter via the gate of entrance; failing to do so triggers an alert to the Monitoring Center 250

In case a Home Owner's alert compels him or her to view the video stream coming from the camera, he or she may decide to open a 2-way audio channel and commence into talking with the visitor. In such a case, the AI system is informed of the dialog commencement, and withholds judgment as long the dialog goes on, while continue tracking the person's whereabout and behavior. Once the 2-way discussion terminates, the AI system expects the visitor to either be admitted inside or to leave the perimeter; failing to do either one of these triggers an alert to the Monitoring Center 250.

The methods and systems that may be used to inform the AI system of the commencement and termination of the 2-way audio dialog with a visitor, maybe via Mobile App notifications from and to the AI system, tapping into the said audio conversation and applying voice processing that interprets human voice activity or applies speech recognition that can interpret contents like conversation opening and termination.

In some embodiments, the AI system may take a queue for the home owner/user conversation with a visitor, such as extending the grace-period timeline as long as the said conversation continues, or on the other hand, detects explicit or implicit user's request for intervention, via Mobile's icon activation, voice recognition text interpretation, or stress indication in either the visitor or the user/home owner voices. Such detection generates human operator intervention in the dialog, and possible further protection means like live loudspeaker warning, scout cars intervention, and law enforcement summoning

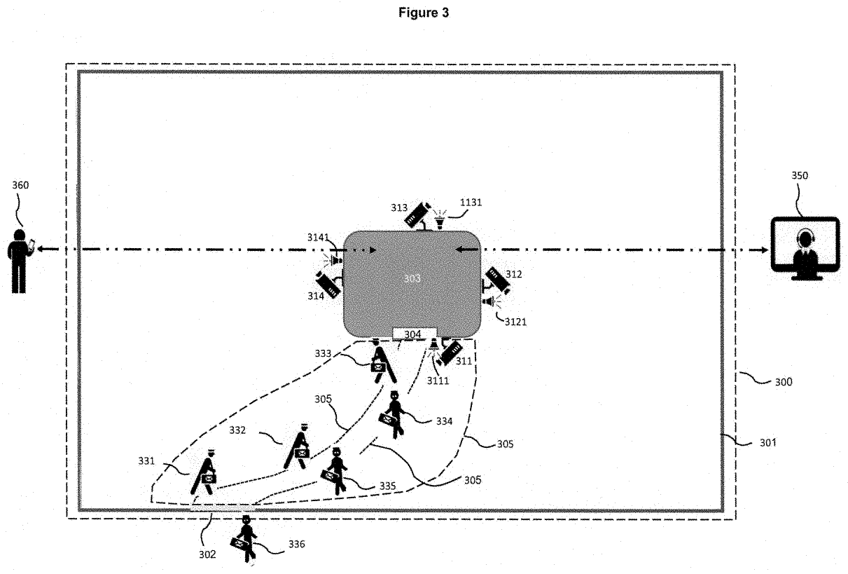

FIG. 3 relates to an apparatus, identical to the one described in FIG. 2, namely, a bordered perimeter with a house inside, protected by cameras & loudspeakers, and all other depicted and identified FIG. 2's components and its monitoring center augmentation.

It depicts a person 331 detected appearing in the gate or some other legitimate entry point to the perimeter, and moving toward the house 303, tracked thru his or her journey e.g. passing thru locations 332 and then 333; reaching the entrance door 304, the camera does not recognizes the person's face, either due to lack of a clear shot, or due to the person being a non-member of the household; the person pauses for very limited time e.g. less than 10 seconds, before turning around and making his or her way back to the perimeter gate and out of the perimeter, for example via locations 334, 335, and 336. As long as the person walks in and out within the confinements of a pre-defined acceptable approaching area 305, also labeled as dwelling zone, and as long as it is done within a pre-defined “brief visit” time period, e.g. 1 minute, also labeled as dwelling time, the AI system considers the person as harmless and the event is discarded. Examples of such well intent approaches are a postman coming in to insert a letter into a mailbox, a deliveryman leaving a package at the doorstep, a visiting neighbor who comes knocking on the door and leaves when no one answers it.

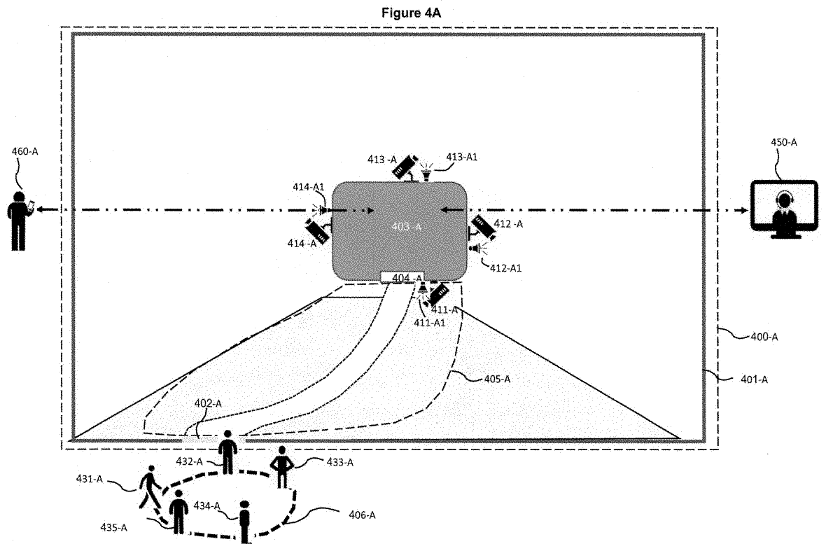

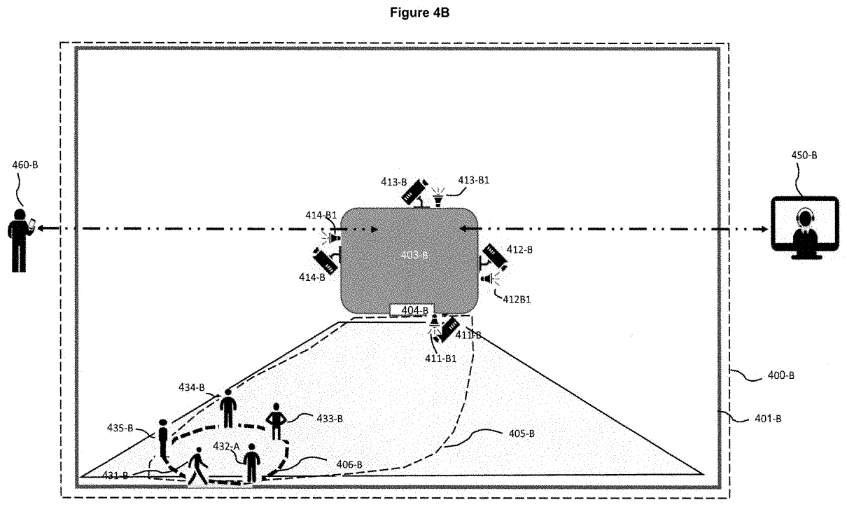

FIG. 4A relates to an apparatus, identical to the one described in FIG. 2, namely, a bordered perimeter with a house inside, protected by cameras & loudspeakers, and all other depicted and identified FIG. 2's components and monitoring center augmentation.

It depicts a person loitering outside the perimeter, close to the gate or the fence or the marked border; the term loitering means standing for an extended period of time e.g. more than 1 minute, or moving back and forth in a confined area 406-A, e.g. detected and tracked by camera 411-A in the locations 431-A thru 435-A for an extended time period e.g. more than 1 minute, or standing and walking alternately within the said confined area during the said extended time.

Upon detections of such a loitering pattern outside a perimeter, close to the gate of fence or a marked border, the AI system alerts the Central Monitoring system 350

FIG. 4B relates to an apparatus, identical to the one described in FIG. 2, namely, a bordered perimeter with a house inside, protected by cameras & loudspeakers, and all other depicted and identified FIG. 2's components and monitoring center augmentation

It depicts a person loitering inside the perimeter; the term loitering means standing for an extended period of time e.g. more than 1 minute, or moving back and forth in a confined area 406-B, e.g. detected and tracked by camera 411-B in the locations 431-B thru 435-B for an extended time period e.g. more than 1 minute, or standing and walking alternately within the said confined area during the said extended time.

Upon detections of such a loitering pattern outside a perimeter e.g. by camera 411, the AI system announce a warning over the loudspeaker 4111, indicating to the person that he or she has been detected entering and is expected to approach the camera and identify him/herself or the kind of business he/she has coming into the perimeter

In case the AI system identifies compliance, it follows a vetting procedure similar to the one described in FIG. 2 above.

In case the AI system identifies non-compliance with the request to approach the camera, it alerts the Central Monitoring system 450, which in turn switches in a remote human operator to take over the management of the event

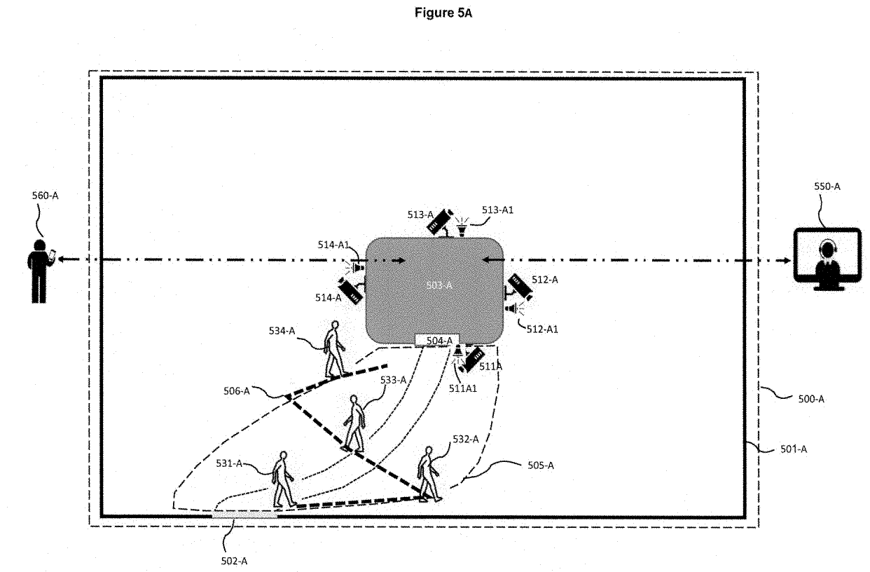

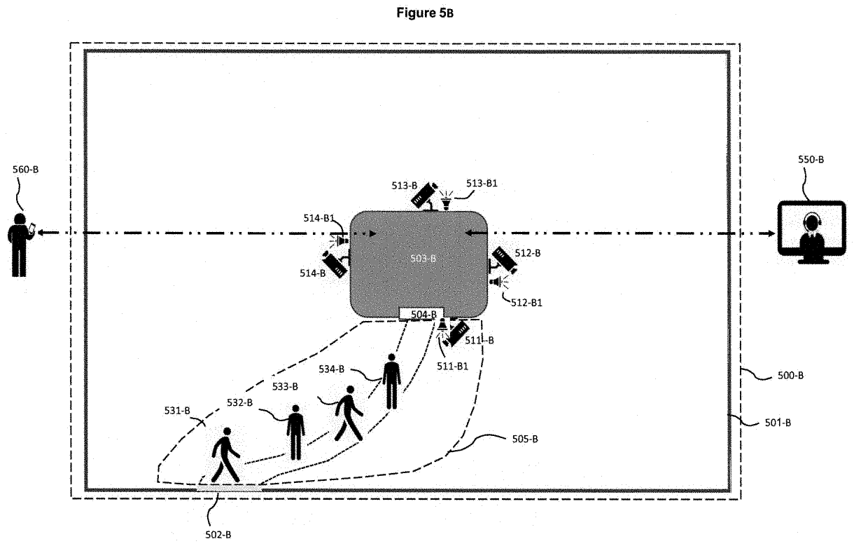

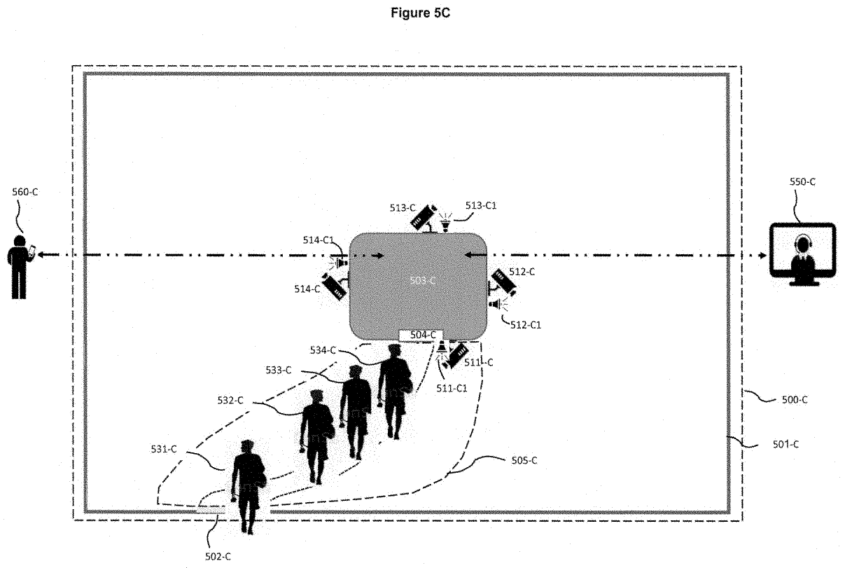

FIG. 5A relates to an apparatus, identical to the one described in FIG. 2, namely, a bordered perimeter with a house inside, protected by cameras & loudspeakers, and all other depicted and identified FIG. 2's components and its monitoring center augmentation.

It depicts a person walking into the perimeter thru a legitimate gate 522-A or yard entrance, moving inside parts of the yard between the gate and the doorway 504-A, while staying inside the Camera 511-A field-of-view (FOV), keeping inside a predefined sector 505-A, which encompasses a permissible approach zone.

The AI system tracks the trajectory of the person's movement, looking for consistency in terms of the chosen course geometry, namely estimating regularity by using metrics like monotonicity, deviations from a best fit, graph continuity and efficiency versus the shortest practical route to the doorway

As an example, the figure shows a person moving between locations 531-A to 534-A, alternating changing directions from time to time

As long as the person's geometric trajectory metrics fall into a certain weighted maximum, the AI system does not take an action

When exceeding the prescribed said geometric limits, machine learning algorithms are activated to corroborate or dismiss the suspicion; when dismissed, the AI system continue tracking and does not take an action

Else, the AI system announces it presence over the loudspeaker 5111-A, indicating to the person that he or she has been detected entering and is expected to approach the camera and identify him/herself or the kind of business he/she has coming into the perimeter

In case the AI system identifies compliance, it follows a vetting procedure similar to the one described in FIG. 2 above.

In case the AI system identifies non-compliance with the request to approach the camera, it alerts the Central Monitoring system 550-A, which in turn switches in a remote human operator to take over the management of the event

FIG. 5B relates to an apparatus, identical to the one described in FIG. 2, namely, a bordered perimeter with a house inside, protected by cameras & loudspeakers, and all other depicted and identified FIG. 2's components and its monitoring center augmentation.

It depicts a person walking into the perimeter thru a legitimate gate 502-B or yard entrance, moving inside parts of the yard between the gate and the doorway 504-B, while staying inside the Camera 511-B field-of-view (FOV), keeping inside a predefined sector 505-B, which encompasses a permissible approach zone.

The AI system tracks the trajectory of the person's movement, looking for temporal consistency of the chosen course, namely estimating speed regularity by looking for start and stop occurrences and absolute speed normalcy, namely detection of too slow or too fast movement versus some average walking pace of an average person, e.g. 2-4 miles per hour.

As an example, the figure shows a person moving between locations 531-B to 534-B, alternating between walking and stopping

As long as the person's temporal metrics fall into a certain weighted maximum, the AI system does not take an action

When exceeding the prescribed said temporal analysis limits, machine learning algorithms are activated to corroborate or dismiss the suspicion; when dismissed, the AI system continue tracking and does not take an action

Else, the AI system announces its presence over the loudspeaker 5111-B, indicating to the person that he or she has been detected entering and is expected to approach the camera and identify him/herself or the kind of business he/she has coming into the perimeter

In case the AI system identifies compliance, it follows a vetting procedure similar to the one described in FIG. 2 above.

In case the AI system identifies non-compliance with the request to approach the camera, it alerts the Central Monitoring system 550-B, which in turn switches in a remote human operator to take over the management of the event

FIG. 5C relates to an apparatus, identical to the one described in FIG. 2, namely, a bordered perimeter with a house inside, protected by cameras & loudspeakers, and all other depicted and identified FIG. 2's components and its monitoring center augmentation.

It depicts a person walking into the perimeter thru a legitimate gate 502-C or yard entrance, moving inside parts of the yard between the gate and the doorway 504-C, while staying inside the Camera 511-C field-of-view (FOV), keeping inside a predefined sector 505-C, which encompasses a permissible approach zone.

The AI system tracks the trajectory of the person's movement, observing the head and in some cases also the shoulders' positions, and specifically looking for abrupt glancing to the left and to the right, several times, e.g. twice or more, when walking towards the house

As an example, the figure shows a person moving between locations 531-C to 534-C, abruptly changing head's directions from left to right

When exceeding some prescribed number of abrupt heads turning, machine learning algorithms are activated to corroborate or dismiss the suspicion; when dismissed, the AI system continue tracking and does not take an action

Else, the AI system announces a warning over the loudspeaker 5111-C, indicating to the person that he or she has been detected entering and is expected to approach the camera and identify him/herself or the kind of business he/she has coming into the perimeter

In case the AI system identifies compliance, it follows a vetting procedure similar to the one described in FIG. 2 above.

In case the AI system identifies non-compliance with the request to approach the camera, it alerts the Central Monitoring system 550-C, which in turn switches in a remote human operator

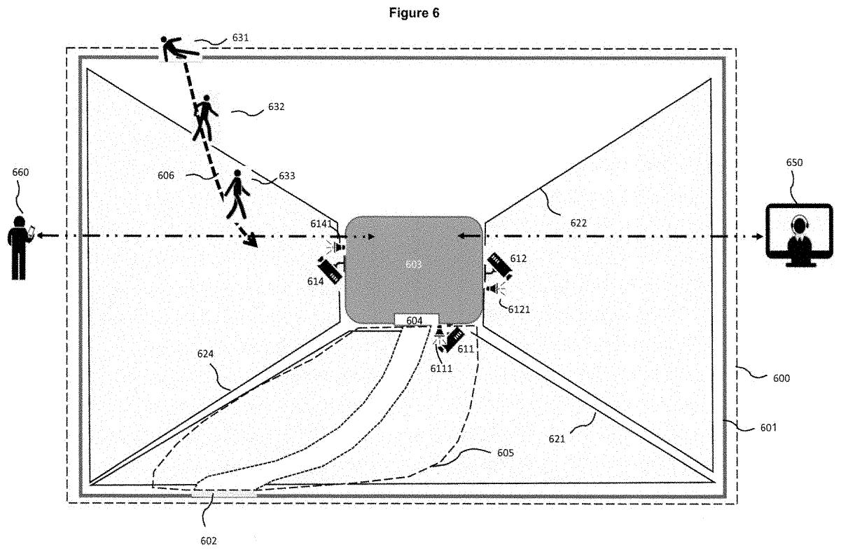

FIG. 6 relates to an apparatus, similar to the one described in FIG. 2, namely, a bordered perimeter with a house inside, protected by cameras & loudspeakers, and other depicted and identified FIG. 2's components and its monitoring center augmentation, with the exclusion of a back pointed camera, which is just an example of a case where the house's camera coverage is incomplete or leaves gaps, allowing for someone to gain access without being detected at a given coverage gap

It depicts a person 631 jumping a fence and proceeding in a trajectory 606, stepping inside a perimeter zone that is uncovered by a camera as depicted by a person 632, and then proceeds along the said trajectory and enters a zone 624 covered by camera 614, as depicted by a person 633.

Upon detecting that person's appearance inside the protected zone, which was not preceded by entrance thru a gate or other legitimate perimeter entrance, it announces thru loudspeaker 6141 a stern warning demanding the person to immediately approach the said camera and identify him/herself.

In case the AI system identifies compliance, it follows a vetting procedure similar to the one described in FIG. 2 above.

In case the AI system identifies non-compliance with the request to approach the camera, it alerts the Central Monitoring system 650, which in turn switches in a remote human operator

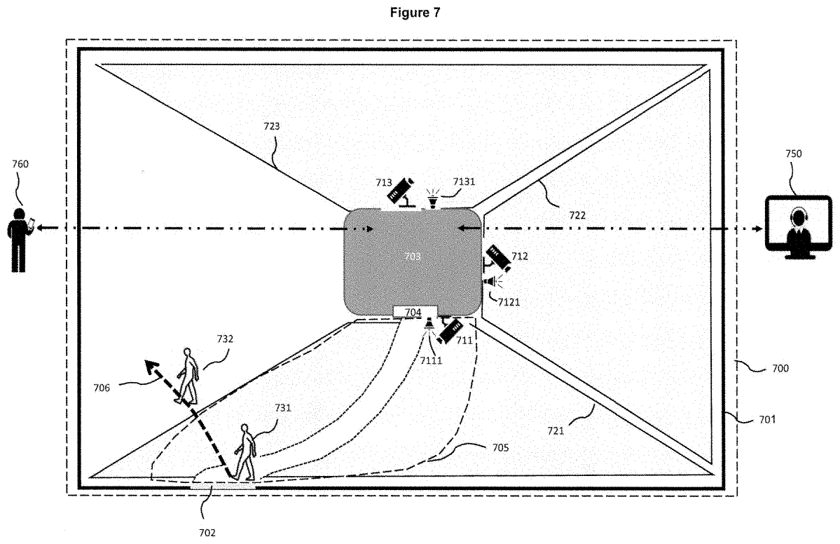

FIG. 7 relates to an apparatus, similar to the one described in FIG. 2, namely, a bordered perimeter with a house inside, protected by cameras & loudspeakers, and other depicted and identified FIG. 2's components and its monitoring center augmentation, with the exclusion of a side pointed camera, which is just an example of a case where the house's camera coverage is incomplete or leaves gaps, allowing for someone may leave coverage of a given zone 721 and step into a zone uncovered by a camera

It depicts detection of a person 731 entering legitimately a 721 zone, covered by camera 711 and proceeds along a route 706, stepping outside the covered zone 721 into an uncovered zone, as depicted by the person 732

Upon detection of disappearance from the camera covered zone 721 towards an uncovered one, done not thru a legitimate perimeter entrance, the AI system announces a warning via the loudspeaker 7111 demanding the person to turn around and approach the camera 711

In case the AI system identifies compliance, it follows a vetting procedure similar to the one described in FIG. 2 above.

In case the AI system identifies non-compliance with the request to approach the camera, it alerts the Central Monitoring system 750, which in turn switches in a remote human operator

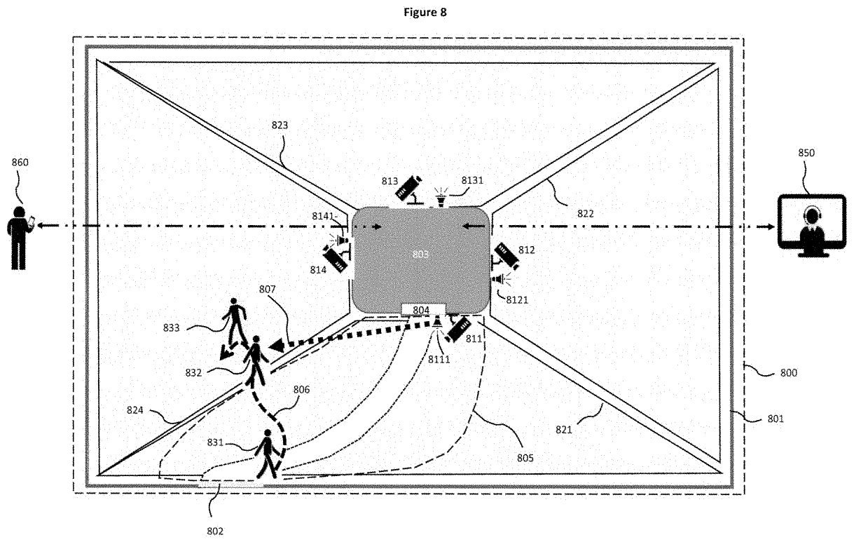

FIG. 8 relates to an apparatus, identical to the one described in FIG. 2, namely, a bordered perimeter with a house inside, protected by cameras & loudspeakers, and all other depicted and identified FIG. 2's components and its monitoring center augmentation.

It depicts a person 831 detected appearing in the gate or some other legitimate entry point to the perimeter, and then, instead of keeping inside a predefined part of the Camera 811 permissible zone 805, the person takes an 806 route outside that permissible zone, e.g. walks to locations 832

Upon detecting that course of leaving coverage, the AI system may announce over the 8111 loudspeaker a warning urging the person to approach a camera for identification, and may track the person's bodily response

In case the AI system machine learning algorithm detects an imminent turn around or head's averting as depicted by 833, immediately after the loudspeaker's announcement 807, in such a time response that appears to be a reaction to the said announcement, it will alert the Central Monitoring center 850

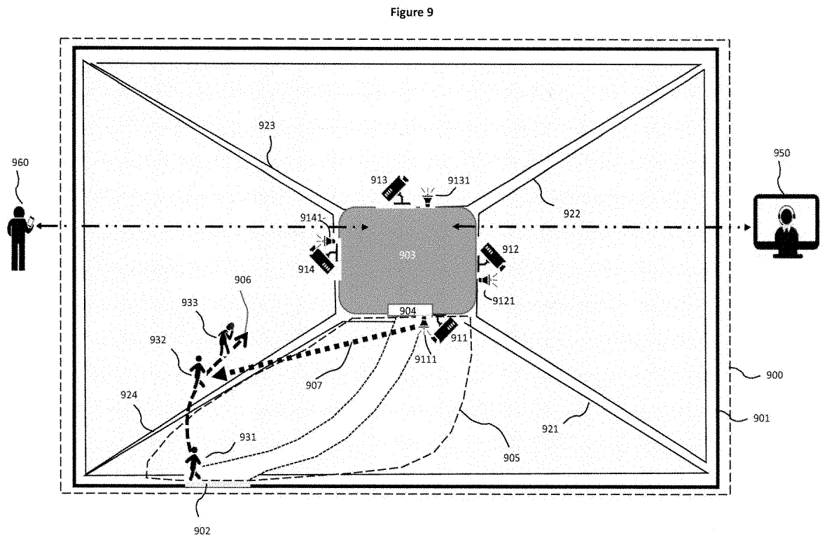

FIG. 9 relates to an apparatus, identical to the one described in FIG. 2, namely, a bordered perimeter with a house inside, protected by cameras & loudspeakers, and all other depicted and identified FIG. 2's components and its monitoring center augmentation.

It depicts a person 931 detected appearing in the gate or some other legitimate entry point to the perimeter, and then, instead of keeping inside a predefined part of the Camera 911 permissible zone 905, the person takes a 906 route outside the said permissible zone, e.g. walks to locations 932

Upon detecting that course of leaving coverage, the AI system announces over the 9111 loudspeaker a warning 907 urging the person to approach a camera for identification, and may track the person's bodily response such as abrupt bodily response such as a sharp stop, or hasty face hiding, or snappy turning around, or breaking into a run

In case the AI system machine learning algorithm detects an imminent effort to hide the face, by wearing a mask, or lowering the head while putting on a hat or a hood as depicted by person 933, immediately after the loudspeaker's announcement 907, in such a time response that appears to be a reaction to the said announcement, it will alert the Central Monitoring center 950

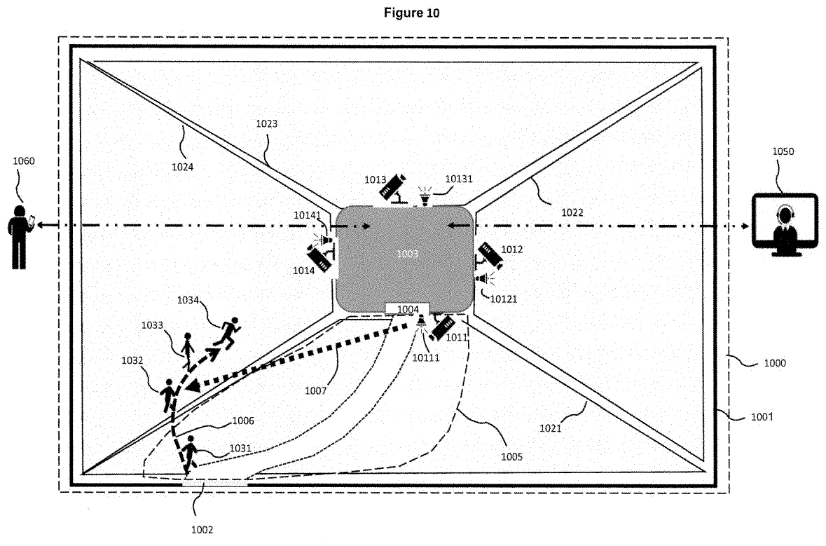

FIG. 10 relates to an apparatus, identical to the one described in FIG. 2, namely, a bordered perimeter with a house inside, protected by cameras & loudspeakers, and all other depicted and identified FIG. 2's components and its monitoring center augmentation.

It depicts a person 1031 detected appearing in the gate or some other legitimate entry point to the perimeter, and then, instead of keeping inside a predefined part of the Camera 1011 permissible zone 1005, the person takes a 1006 route outside the said permissible zone, e.g. walks to locations 1032

Upon detecting that course of leaving coverage, the AI system announces over the 10111 loudspeaker a warning 1007 urging the person to approach a camera for identification, and may track the person's bodily response

In case the AI system machine learning detects the person significantly changing his or her pace, e.g. person 1034 breaks into a run, immediately after the loudspeaker's announcement 1007, in such a time response that appears to be a reaction to the said announcement, it will alert the Central Monitoring center 1050

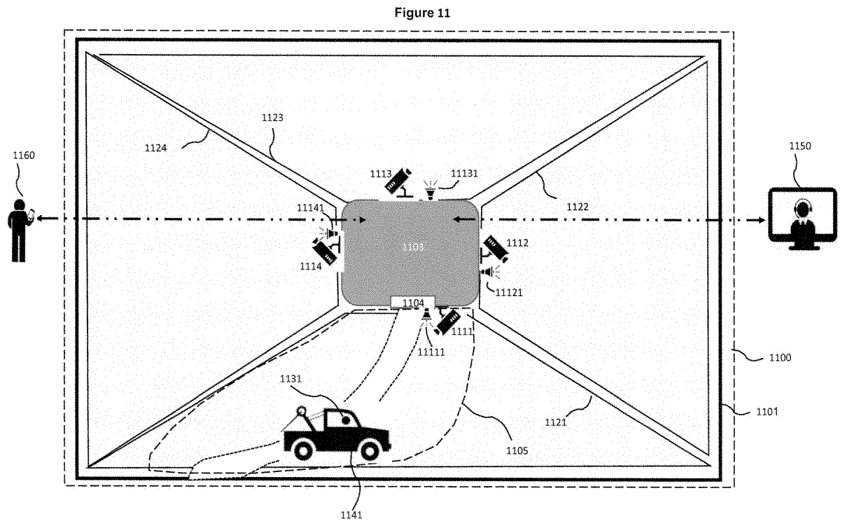

FIG. 11 relates to an apparatus, identical to the one described in FIG. 2, namely, a bordered perimeter with a house inside, protected by cameras & loudspeakers, and all other depicted and identified FIG. 2's components and its monitoring center augmentation.

It depicts a vehicle 1141 driving into the perimeter, parking, and then the driver 1131 does not get out of the car for an extended period of time, e.g. over 1 minute

The AI system responds by announcing a request to the driver to get out of the car

In case the AI system detects compliance, e.g. the driver gets out and steps towards the door, it follows a vetting procedure similar to the one described in FIG. 2 above.

Else, the Central Monitoring is alerted

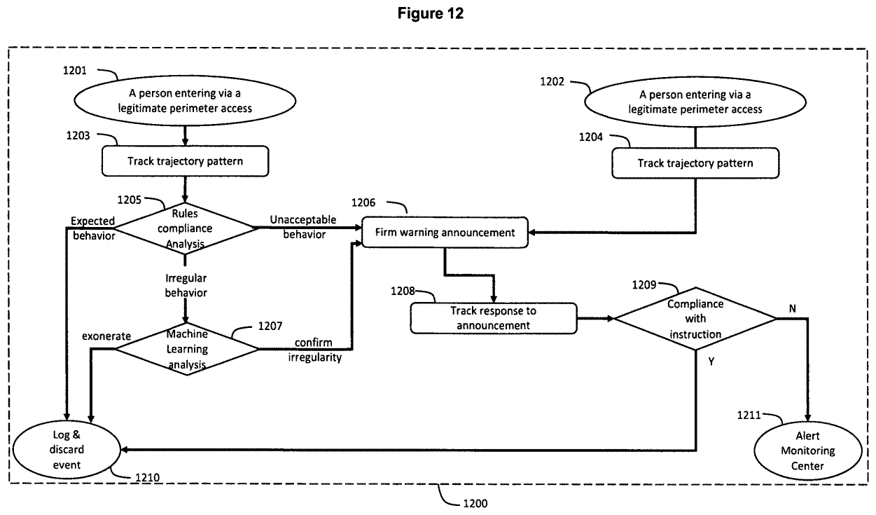

FIG. 12 is a flowchart outlining the use of an escalatory set of vetting means aimed to handle an appearance of a person inside a computer vision based protected perimeter. Upon detection of a person inside the protected area, the AI system first determines if the person entered via a legitimate entrance 1201—e.g. a gate, a non-gated opening in a fence, a path stretching between the public area and the house's doorway—or gained entry via in an illegitimate way 1202—e.g. jumping over a fence, walking thru a hedge growing on the perimeter border, moving in from a neighboring perimeter via a loosely marked or un-marked border.

While entering legitimately causes the AI system to track and analyze the person's trajectory 1205, waiting to see if the person behaves in an expected way, the illegitimate entrance case receives an immediate treatment: While tracking the potential intruder 1204, the AI system sends via a loudspeaker a warning announcement 1206, indicating to that person that he or she were detected, and demanding immediate approach to the loudspeaker's adjacent camera for identification.

Back to the legitimate entrance, the AI system analyzes the person's trajectory and behavior 1205, dividing its conclusions into 3 possible cases: Expected behavior, unacceptable behavior, and an inconclusive result, where the behavior is irregular but not yet threatening.

A person who follows expected patterns is tagged as non-threatening, causing the event to be discarded as indicated by 1210; a person who clearly behaves in an unacceptable way is treated with a firm loudspeaker warning as depicted above by 1206

A person that is tagged as irregular, undergoes further AI system analysis via a machine learning processing 1207 which either exonerates him or her from suspicion, or confirms it and announces a warning per the said 1206

Following the AI system's announcements, the person response is tracked as per 1208 and when compliance verification 1209 to the said warning is observed, the person is tagged as a harmless and the event is discarded per 1210; lack of compliance results in an alert to the central monitoring system 1211.

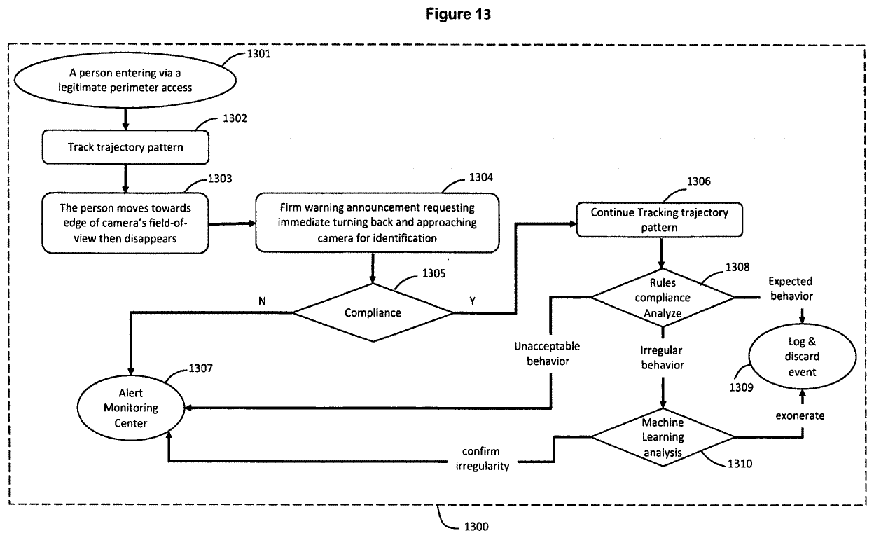

FIG. 13 is a flowchart outlining the way the said AI system handles a suspicious disappearance of a person from the camera's field of view (FOV).

When a person is detected coming into the perimeter via a legitimate entrance as per 1301, the AI system tracks it per 1302, as it does in all detections events

In case the person angles out to exit the camera field-of-view as per 1303, the AI system announces a warning 1304, and then looks for compliance with its instructions per 1305. The AI system then continue tracking the person, analyzing compliance with the instruction as per 1308, and if matches expected behavior, it tags the event as harmless discard it as indicated in 1309.

Irregular behavior gets scrutinized by a machine learning processing 1310;

Failure to comply in either first level of scrutiny, e.g. evident wrong trajectory, or second level, e.g. ignoring loudspeaker's instruction, or third one, e.g. continuing irregular behavior and not passing the machine learning processing, cause an alert to the central monitoring or other human guard entity 1307

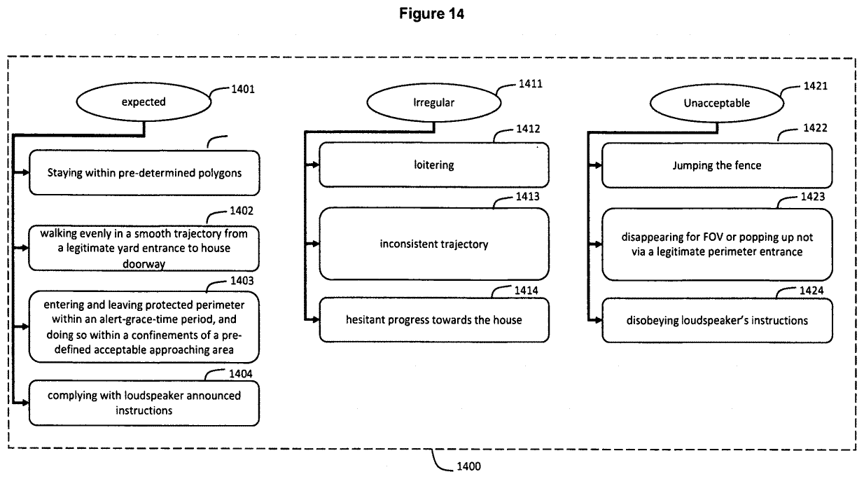

FIG. 14 outlines criteria the invention uses to classify behavior into types, which may split into 3 categories: Expected 1401, irregular 1411, unacceptable 1421

Under expected behavior this invention lists a purposeful walking trajectory 1402, where a person walks in a consistent, monotonic and smooth trajectory between the entry point to the doorway of the house

It also labels ‘expected’ in 1403 when someone stays in the perimeter only briefly; examples are, a home owner would enter the perimeter, gain access via face recognition and enters the house, no longer in the protected area, while delivery person or a mailman would enter, approach the doorstep and leave immediately

Expected behavior is also considered as such when a person is detected as complying with the loudspeaker instructions as in 1404; for example, starting to walk toward the camera in response to an announced demand

Under irregular behavior this invention lists loitering 1412, which is standing or walking back and forth, close to the perimeter border or inside it, for more than a fraction of a minute; such behavior is associated with potential scouting activity, typically done by burglars

Under irregular this invention also lists an inconsistent or uneven trajectory 1413 and 1414, where a person walks in with trajectory changes or with pace changes; such behavior is associated with potential ill intent or hesitant intruder's progress

Under unacceptable behavior this invention lists fence jumping 1422, evidently an illegitimate entry

Also unacceptable is a disappearance of a person from a camera coverage zone 1423, associated with a potential effort to stay in the protected perimeter but evade detection or avoid identification

Unacceptable behaviors also include any ignoring or disobeying of the loudspeaker instructions as per 1424; an example of ignoring is not altering a diverging trajectory after loudspeaker waring; examples of disobedience are hiding face, breaking into running, staying away of the camera in spite of the specific demand over the loudspeaker

1. A computer vision assisted cameras system, configured to protect a perimeter from intruders while allowing legitimate visitors' entrance, comprising automatic tracking and analyzing people's behavior, wherein the method of sorting is based on route trajectory characteristics and movement consistency or on duration of dwelling in a protected zone

2. A method according to claim 1, wherein the route trajectory of a person is scrutinized for purposefulness of getting from a perimeter entrance to a doorway of a house or building inside, or vice versa, wherein purposefulness level is determined by monotonicity of the trajectory in geometrical and temporal dimensions

3. A method according to claim 2, wherein lack of monotonicity in geometrical terms is defined as noticeable direction changes, beyond those that are necessary for bypassing obstacles

4. A method according to claim 2, wherein the lack of monotonicity in temporal terms is defined as noticeable pace changing including stopping and resuming progress

5. A method according to claim 2, wherein analysis of lack of monotonicity in either geometric or temporal terms triggers machine learning processing that is tasked to corroborate or dismiss the said analysis

6. A method according to claim 1, wherein areas of permissible dwelling zones are defined, as well as alert-grace-period timelines of staying in said permissible dwelling zones so that a person who enters the permissible dwelling zone and then leaves it within the grace-period timeline, is considered purposeful and therefore harmless

7. A computer vision assisted cameras system, configured to protect a perimeter from intruders while allowing legitimate visitors' entrance, comprising automatic tracking and analyzing people's behavior, wherein the method of sorting is based on demeanor and compliance and with automated instructions announced over loudspeakers attached to the cameras

8. A method according to claim 7, wherein when the AI system identifies irregular visitor's behavior it may announce a warning and then tracks the resultant behavior of the visitor for compliance or ignoring or defiance, tagging the person as harmless, or non-responding or suspicious, respectively

9. A method according to claim 7, wherein compliance tag is granted when following a warning announcement’ the person stops what he or she were doing and start doing what is required

10. A method according to claim 7, wherein sorting is based on detected body language observed immediately after a loudspeaker announcement

11. A method according to claim 7, wherein the system identifies said irregular visitor behavior and issues said loudspeaker warning over a loudspeaker and then tags a person as suspicious if observing an imminent abrupt bodily response

12. A computer vision assisted cameras system, configured to protect a perimeter from intruders while allowing legitimate visitors' entrance, comprising automatic tracking and analyzing people's behavior, wherein the method of sorting may be assisted by an automated processing of a home owner's audio-visual dialog with a visitor

13. A method according to claim 12, wherein homeowner's audio-visual dialog with a visitor, is monitored by the AI system, for the purpose of identifying start and stop of such dialog, or for picking voice-based instruction for the home-owner to the AI system, such as extension of alert-grace-period, or for identifying distress in the homeowner words or tone that warrants human guard intervention.
